(19) United States
(12) Patent Application Publication
(10) Pub. No.: US 2017/0257059 A1
(43) Pub. Date: Sep. 7, 2017

(54) ARRANGEMENTS OF A PLURALITY OF PHOTOVOLTAIC MODULES

(71) Applicant: SolarWorld Americas, Inc., Hillsboro, OR (US)

(72) Inventors: Martin Kutzer, Penig (DE); Matthias Georgi, Dresden (DE); Nathan Stoddard, Beaverton, OR (US); Beryl Weinshenker, Portland, OR (US); Steven Meredith, Bonn (DE)

(21) Appl. No.: 15/062,236

(22) Filed: Mar. 7, 2016

(51) Int. Cl. H02S 40/22; H02S 20/20; H02S 30/10; H02S 20/25

(52) U.S. Cl. CPC H02S 40/22; H02S 20/25; H02S 20/20; H02S 30/10

(57) ABSTRACT

Various embodiments are related to an arrangement of a plurality of photovoltaic modules. Each photovoltaic module has a light receiving front side and a light receiving back side. The photovoltaic modules of the plurality of photovoltaic modules are arranged in one or more rows to form photovoltaic module rows. One or more photovoltaic module rows are extended substantially in a direction of around North-South and the front sides of the photovoltaic modules of the one or more photovoltaic module rows are sloped substantially in a direction of predominantly North or South. The arrangement further has a plurality of mounting members. Each mounting member defines a space between respective two photovoltaic modules in one photovoltaic module row that are mechanically connected with the respective mounting member. Each mounting member of the plurality of mounting members has a bottom part; a long leg; and a short leg. The long leg and the short leg respectively extend upwards from an end of the bottom part. The mounting members further have a reflector configured to reflect light to the back side of at least one of the connected photovoltaic modules.

### TECHNICAL FIELD

Various embodiments relate generally to arrangements of a plurality of photovoltaic modules.

### BACKGROUND

FIG. 1 shows an arrangement of photovoltaic modules, e.g. a solar park on a roof 100 or ground 100. In this arrangement, the photovoltaic modules have a light receiving front side and an optically inactive back side. Further, in this arrangement, a first and a second plurality of photovoltaic modules is arranged in first 102 and second 104 rows of photovoltaic modules in a roof-shaped manner. An edge of the first and second rows 102, 104 forms the ridge of a roof. The front sides of the photovoltaic modules of the first plurality are faced to the West (W) and the front sides of the photovoltaic modules of the second plurality are faced to East (E). In a conventional arrangement, in which photovoltaic modules are faced to the South (S), a peak energy yield occurs around noon. This peak may stress the grid of the arrangement and/or may cause a lower domestic consumption. A solar park as illustrated in FIG. 1 has peak energy yields in the morning and in the afternoon and, thus, the peak around noon is smoothed. However, the photovoltaic modules are not oriented ideally to the South with their front side and, thus, an arrangement of FIG. 1 has a lower specific energy yield than an arrangement of photovoltaic modules arranged to the South with their front sides. Thus, the levelized cost of energy (LCOE) of a solar park of FIG. 1 is increased.

Bifacial photovoltaic modules each having a light receiving front side and a light receiving back side are used in buildings (building integrated photovoltaic—BIPV), i.e. on a south-facing wall, vertical in East-West orientation (E-W) and standard slanted installation with south facing orientation. Bifacial photovoltaic modules may in principle be suitable to decrease the LCOE of the arrangement of FIG. 1. However, bifacial photovoltaic modules are not suitable for the known East-West arrangement of photovoltaic modules of FIG. 1. In the arrangement of FIG. 1, the second rows 104 of photovoltaic modules are shading the back side of photovoltaic modules of the first row 102 and vice versa. Thus, light falling on the arrangement may not be able to reach the back side of bifacial photovoltaic modules because of the roof-shaped arrangement of the photovoltaic modules in the rows 102, 104. Moreover, outside of the constraints of BIPV, existing arrangements tend to compromise the front side light capture and per-area energy yield in order to get better back-side insulation. This can artificially boost ‘energy yield’ per module at the expense of total area energy yield.

Further, bifacial photovoltaic modules oriented with their front side in a South direction are generally mounted a certain level above the ground using a mounting provision that provides a gap between the ground and the photovoltaic modules for the light from the South direction. This way, that light may fall in on the back side of the bifacial photovoltaic modules through the gap and, thus, generating substantially the additional energy yield of bifacial photovoltaic modules. However, the level above ground inflicts additional costs since larger loads from wind are acting on the mounting provision.

### SUMMARY

In various embodiments, an arrangement of a plurality of photovoltaic modules is provided. Each photovoltaic module has a light receiving front side and a light receiving back side. The photovoltaic modules of the plurality of photovoltaic modules are arranged in one or more rows to form photovoltaic module rows. One or more photovoltaic module rows are extended substantially in a direction of around North-South and the front sides of the photovoltaic modules of the one or more photovoltaic module rows are sloped substantially in a direction of predominatly North or South. The arrangement further has a plurality of mounting members. Each mounting member defines a space between respective two photovoltaic modules in one photovoltaic module row that are mechanically connected with the respective mounting member. Each mounting member of the plurality of mounting members has a bottom part; a long leg; and a short leg. The long leg and the short leg respectively extend upwards from an end of the bottom part. The mounting members further have a reflector configured to reflect light to the back side of at least one of the connected photovoltaic modules.

This way, the amount of light that is collected from the back side of a bifacial photovoltaic module is increased, e.g. without shading or impeding the front side of other photovoltaic modules and without sacrificing too much in area packing density of modules. Thus, using the arrangement of photovoltaic modules according to various embodiments, light is used that is normally wasted due to sun transit angles in order to boost energy yield from a bifacial photovoltaic module while maintaining high area energy yield. Hence, efficient all-day light capture may be enabled using both sides of a bifacial photovoltaic module. The energy yield of photovoltaic modules according to various embodiments may be comparable with the energy yield of a standard arrangement of monofacial photovoltaic modules but may have a broadened or smoothed yield curve. Thus, a reduced grid stress and/or an improved domestic consumption may be achieved. These effects may be especially prominent on substantially planar grounds, e.g. planar grounds or roofs.

The bifacial photovoltaic modules of arrangements according to various embodiments may be arranged with an edge on the ground, e.g. a ground and, thus, may avoid above described problems allowing a simplified installation.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows schematically a perspective view of a known arrangement of photovoltaic modules;

FIG. 2 shows schematically a perspective view of an arrangement of photovoltaic modules according to various embodiments;

FIG. 3A and FIG. 3B show schematically cross sections of an arrangement of photovoltaic modules according to various embodiments;

FIG. 4 shows a schematic top view and a schematic side view of an arrangement of photovoltaic modules according to various embodiments;

FIG. 5 shows a schematic top view and a schematic cross section of an arrangement of photovoltaic modules according to various embodiments;

FIG. 6 shows a schematic perspective view of an arrangement of photovoltaic modules according to various embodiments;

FIG. 7A to FIG. 7D show schematic perspective views of an arrangement of photovoltaic modules according to various embodiments;

FIG. 8 shows a schematic perspective view of an arrangement of photovoltaic modules according to various embodiments;

FIG. 9 shows a schematic perspective view of an arrangement of photovoltaic modules according to various embodiments; and

FIG. 10 shows a schematic perspective view of an arrangement of photovoltaic modules according to various embodiments.

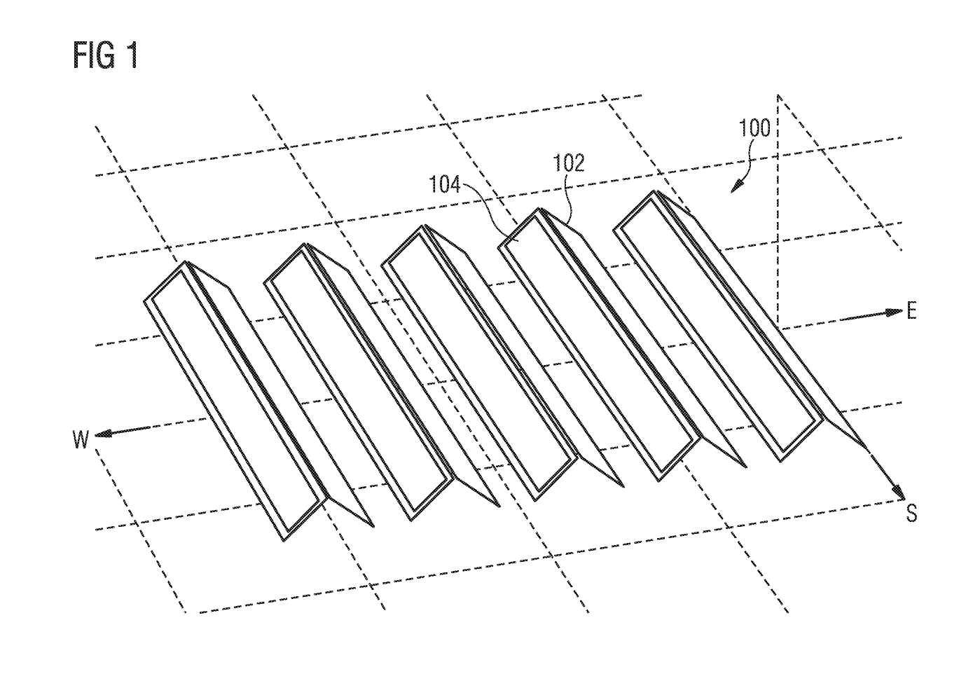

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

A photovoltaic module according to various embodiments may have at least one solar cell, e.g. two or more solar cells. The at least one solar cell may be a bifacial solar cell. A bifacial solar cell has a light receiving front side and a light receiving back side and may generate an electrical energy from light falling in on the front side and/or on the back side. Further in the photovoltaic module, the at least one solar cell may be embedded in a transparent embedding material, e.g. ethylene vinyl acetate (EVA). In various embodiments, the embedding material, and thus the solar cell, may be framed by means of a frame profile for mounting or holding the photovoltaic module. Alternatively, the photovoltaic module may be frame less. In various embodiments, the photovoltaic module according to various embodiments may be a bifacial photovoltaic module.

In various embodiments, the solar cell may include a first electrode, a second electrode, and an optically active region between the first electrode and the second electrode. The first electrode may be formed directly on the optically active region, i.e. on the front side, in the beam path of the absorbable electromagnetic radiation. The electromagnetic radiation is converted into an electrical voltage and/or electric power in the optically active region.

The first electrode may be formed as a front side contact or front surface metallization. The front contact structure may be formed over the optically active region, for example as a finger-shaped metallization or in the form of a selective emitter or as a combination thereof. A patterned front side metallization is substantially formed only on the optically active region (except for electrical cross-links).

The optically active area of the solar cell may include an electrically conducting and/or semiconducting material, for example a doped silicon, for example a p-doped silicon (p-type), doped with boron, gallium and/or indium, for example, or a n-doped silicon (n type), doped with phosphorus, arsenic and/or antimony, for example. The optically active region may include a first region which may be doped with a different dopant than a second region, and has a physical contact with this. For example, the first region may be a p-type region (doped with a p-type dopant) and the second region may be an n-type region (doped with n-dopant), and vice versa. At the interface of the first region to the second region, a pn-junction is formed that may generate electron-hole pairs. The optically active area may absorb electromagnetic radiation and form a photocurrent thereof. The optically active region may include a plurality of pn junctions, for example juxtaposed and/or superposed. The electromagnetic radiation may have a wavelength range of x-rays, ultraviolet radiation (A to C), visible light and/or infra-red radiation including (A to C).

On the back side of the solar cell, a back side contact structure may be formed. The back-contact structure may include the second electrode.

An above described photovoltaic module may also be denoted as a panel, a PV module or module.

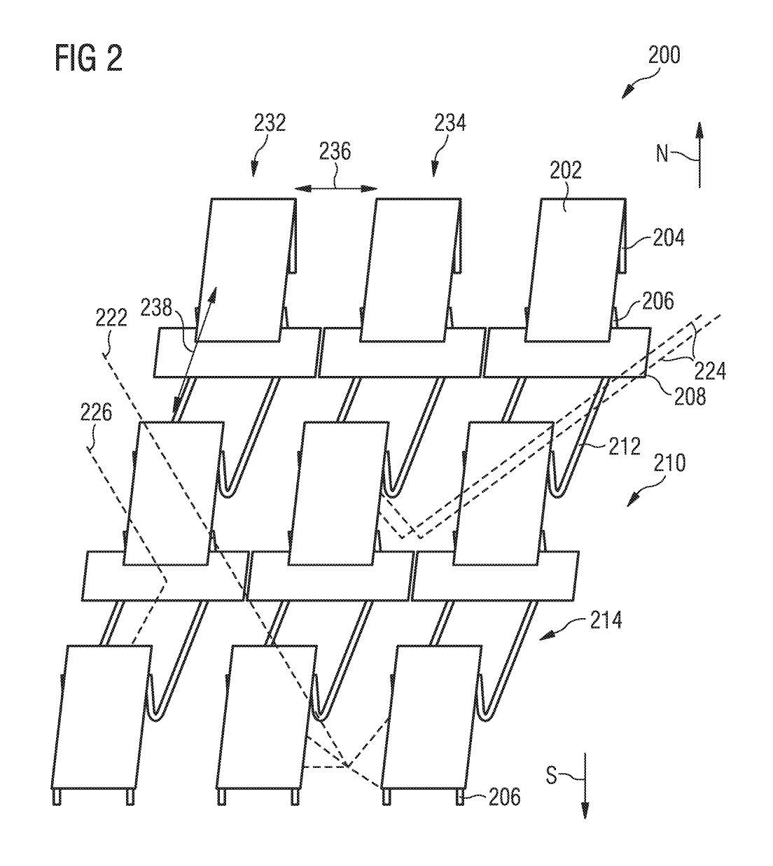

FIG. 2 shows schematically a perspective view of an arrangement 200 of photovoltaic modules 202 according to various embodiments. In various embodiments, the arrangement 200 of photovoltaic modules 202 includes a plurality or multiplicity of photovoltaic modules 202.

The photovoltaic modules 202 have a light receiving front side and a light receiving back side. The photovoltaic modules 202 of the plurality of photovoltaic modules are arranged in one or more rows to form photovoltaic module rows 232, 234, e.g. consecutively in one or more photovoltaic module rows (in FIG. 2 are shown three photovoltaic module rows). A space 238 is formed respectively between photovoltaic modules 202 of a photovoltaic module row 232, 234, i.e. between directly adjacent photovoltaic modules 202. Two or more photovoltaic module rows may be arranged in various embodiments to form an inter-row space 236 between the photovoltaic modules of directly adjacent photovoltaic module rows respectively.

In other words, in various embodiments, the arrangement has at least a first photovoltaic module row 232 and a second photovoltaic module row 234 of photovoltaic modules 202. The first photovoltaic module row 232 may be about parallel to the second photovoltaic module row 234. An inter-row space 236 may be formed between the first photovoltaic module row 232 and the second photovoltaic module row 234.

The arrangement may have a ground 210. The ground 210 may be, as example, a roof of a building or a ground. The photovoltaic modules may be arranged on or above the ground 210. In various embodiments, the ground 210 may be substantially flat. Alternatively, the ground 210 may have a curved surface. In this case, the space 238, 236 between adjacent photovoltaic modules may be adapted depending on the curvature of the ground, e.g. to maintain about equal illumination conditions across the arrangement.

One or more photovoltaic module rows are extended substantially in a direction of North-South (N-S), as shown in FIG. 2. The front sides of the photovoltaic modules 202 of these one or more photovoltaic module rows may be sloped, in other words: arranged in an angle regarding the ground 210, substantially in a direction of the extension of their respective photovoltaic module row.

The plurality of photovoltaic modules 202 may be mounted on the ground 210 by means of a plurality of mounting members. In various embodiments at least some of the photovoltaic modules 202 of the plurality of photovoltaic modules 202 are mechanically connected with at least some of the mounting members 214 of the plurality of mounting members 214. In various embodiments, at least two photovoltaic modules 202 of one photovoltaic module row are connected with one mounting member 214. At least some of the mounting members 214 of the plurality of mounting members 214 may be configured to define the space 238 between two photovoltaic modules 202 in one photovoltaic module row that are mechanically connected with the respective mounting member 214.

In various embodiments, the mounting members 214 of the plurality of mounting members 214 respectively have a bottom part 212; a long leg 204 and a short leg 206 that respectively extend upwards from an end of the bottom part 212. The long leg 204 is longer than the short leg 206. The photovoltaic modules 202 may bear on (in other words supported by) or may be mounted by the mounting members 214, e.g. the legs 204, 206. This way, the slope of the photovoltaic modules 202 may be arranged, configured or adjusted. In other words, the photovoltaic modules may be respectively bear on the long leg 204 and the short leg 206. The bottom part 212 of the mounting members may bear on the ground 210. Thus, the photovoltaic modules 202 may be arranged on the ground 210 by the bottom part 212. In other words: the long leg 204 and the short leg 206 are configured to position a portion of a photovoltaic module close to the long leg 204 higher above the ground 210 than the a portion of the photovoltaic module close to the short leg 206.

Further, in various embodiments, the mounting members 214 may have at least one reflector 208. The reflectors 208 may be configured to reflect light 226 to the back side of at least one of photovoltaic modules 202 that is connected with the respective mounting member 214. Alternatively or in addition, light 224, 226 may be reflected from the substrate 210 onto the back side of the photovoltaic modules 202. The front sides and the back sides of the photovoltaic modules generate an electrical energy and the back sides may increase the specific energy yield of the arrangement 200. In addition, the arrangement may smooth the energy yield peak that occurs around noon at common arrangements.

In other words, in various embodiments, the reflector 208 may be formed in the space 238 between the photovoltaic modules 202 that are connected with the respective connecting mounting member 214. In various embodiments, the reflectors 208 may be formed in the space 238 between the long leg 204 and the short leg 206. Thus, in various embodiments, at least one reflector 218 may be formed or positioned between two photovoltaic modules that are connected with a mounting member close to the portion of a photovoltaic module 202 that bears on the short leg 206 of the mounting member. In various embodiments, the reflector 208 may formed or positioned below or under at least one of the photovoltaic modules that are connected with the mounting member.

In other words, the mounting members 214 may be formed having a reflector 208 or may be configured to bear at least one reflector 208. At least one reflector may be arranged, formed or positioned between the long leg 204 and the short leg 206, e.g. on, above, below or included in the bottom part 212 of the mounting member 212, e.g. as a part of the bottom part 212.

In various embodiments, the front sides of the photovoltaic modules 202 of the one or more photovoltaic module rows may be sloped substantially in a direction of North (N) or South (S).

In various embodiments, a substantial or predominant direction, e.g. North, is a preferred direction can be understood as a direction in a range from about Northwest to about Northeast, e.g. a value in a range of North ±30 degrees, e.g. a value in a range of North ±25 degrees, e.g. a value in a range of North ±20 degrees, e.g. a value in a range of North ±10 degrees, e.g. a value in a range of North ±5 degrees. This applies mutatis mutandis for other embodiments and for other directions, e.g. South, East, West, Southwest etc.

In various embodiments, the one or more photovoltaic module rows of photovoltaic modules 202 may be arranged or oriented to form one or more photovoltaic module rows that extend in North-South (N-S) direction. The front side of the photovoltaic modules 202 may be sloped in a direction of the one or more photovoltaic module row of the photovoltaic modules, i.e., as illustrated in FIG. 2, the photovoltaic modules may be sloped in a direction of South (S). The slope of the photovoltaic modules 202 may be formed or arranged by means of the at least one mounting member that is connected with photovoltaic module respectively. In various embodiments, the slope of the photovoltaic modules 202 may be formed or arranged by means of the long leg 204 and short leg 206 of the mounting member. A photovoltaic module 202 that is sloped in a direction of North-South may be understood as having a height gradient regarding the ground 210 surface in the direction of North-South. As example, the edge closest to the North of a photovoltaic module 202 be positioned higher above the ground 210 than the edge closest to the South of the same photovoltaic module 202. Thus, a slope is formed.

In other words, the photovoltaic modules 202 may be arranged in photovoltaic module rows with space in between directly adjacent photovoltaic modules 202. The in-between space 236, 238, that is the space between the photovoltaic modules and/or the inter-row space, may be engineered to maximize back-reflectance (Albedo) of incoming light (illustrated in FIG. 2 with the dashed lines 222, 224, and 226). Therefore, in various embodiments, there are reflectors 208 arranged in the in-between space 236, 238 to increase the reflectance. This way, as the sun travels from East to West, light 222, 224, 226 from the in-between space 236, 238 may be reflected to the back side of the photovoltaic modules. At mid-day, diffuse reflection 222, 224 may illuminate the back side of the photovoltaic modules, e.g. together with the reflectors 208.

In other words: FIG. 2 shows a south-facing bifacial panel racking of photovoltaic modules. The mounting members are formed like vertical retainers for the photovoltaic modules. The mounting members may include for each module at least one reflector 208, e.g. a series of reflectors. The reflectors 208 may be made from inexpensive materials, e.g. mylar films, aluminum foils or polished metal layers. A first segment or portion of the reflectors 208, e.g. a portion of the reflector 208 that is closest to the front face of the photovoltaic module 202 respectively, is about a flat reflector designed to reflect light up from the ground 210 onto the front side of the photovoltaic module 202. A second section or portion of the reflectors 208, e.g. a portion of the reflector 208 that is further away from the photovoltaic module 202 than the first portion, may be formed in non-planar manner, e.g. having v-shaped ridges with the reflecting face pointing forward to the back side of the photovoltaic module 202 in the next photovoltaic module row in front of the current photovoltaic module 202. The inter-row space 236 between the photovoltaic module rows of the photovoltaic modules 208 is designed so that about all or a substantial amount of light may be collected on the front side of the photovoltaic modules 208 under low incidence angle conditions of the light that falls on the arrangement 200, e.g. in the morning/evening and under winter conditions. The inter-row space may be designed so that the top of the photovoltaic modules 208 of one photovoltaic module row does not shade the bottom of the photovoltaic modules 208 of a next, adjacent or consecutive photovoltaic module row. The vertical position of the photovoltaic modules and a large inter-row space 236 would normally create very poor solar collection conditions when the sun is high in the sky. The mirror optics of the reflectors 208 and the bifacial features of the photovoltaic modules 202 are heavily relied upon in these conditions to get as much light collection as possible. In mid-day and mid-summer conditions light 222 coming in closer to vertical is falling in between the photovoltaic module rows. The reflectors 208, e.g. from the second portion of the reflector 208, may reflect the light 222 with a part falling in onto the back side of the photovoltaic modules in front of the reflector 208. Another part of this light 222 may be reflected from the reflector 208, e.g. the first portion of the reflector 208, onto the front side of the photovoltaic module behind the reflector 208. Further, the inter-row spaces may allow light 222, 224 from a Southern direction to fall in on the back side of the photovoltaic modules, e.g. under the section or portion of the photovoltaic module close to the short leg 206 of the mounting members.

In various embodiments, the reflectors 208 may be configured to be free of a flat or non-curved light reflecting surface. This way, an accumulation of water, ice or debris may be reduced or omitted.

Photovoltaic modules having a flat glass may have a poor light collection at high incidence angles of the light relative to the normal of the photovoltaic module plane because of reflection. Hence, according to various embodiments, the photovoltaic module may have a textured glass, anti-reflective layers or structured glass to collect the light into the photovoltaic module.

The arrangement of photovoltaic modules in FIG. 2, e.g. on a commercial roof top, may have no or may have a reduced up-lift from wind coming along the photovoltaic modules 202. Thus, required ballast for holding down the photovoltaic modules may be limited or reduced. With this in mind, a ballast of various embodiments is a material that is used to increase the stability of the arrangement. Thus, the main hardware, i.e. the mounting members and/or the ballasts, may only be required for preventing that the photovoltaic modules are falling over. The photovoltaic modules 202 may be mounted on the ground 210 e.g. in a portrait orientation or a landscape orientation. The inter-row space 236 may be adapted for the corresponding orientation to keep the same height to spacing ratio.

It may be sufficient to secure the bottom quarter of the vertical sides of the respective photovoltaic modules 202. Hence, the mounting members may be formed in a technically simple manner, e.g. from inexpensive materials or in a structure that is inexpensive to form. In addition, a lack of ballast or the reduced or limited ballast makes this arrangement a very light system that. Thus, the arrangement may be suitable for grounds 210, e.g. flat roof tops that would be not suitable for common arrangements of photovoltaic modules.

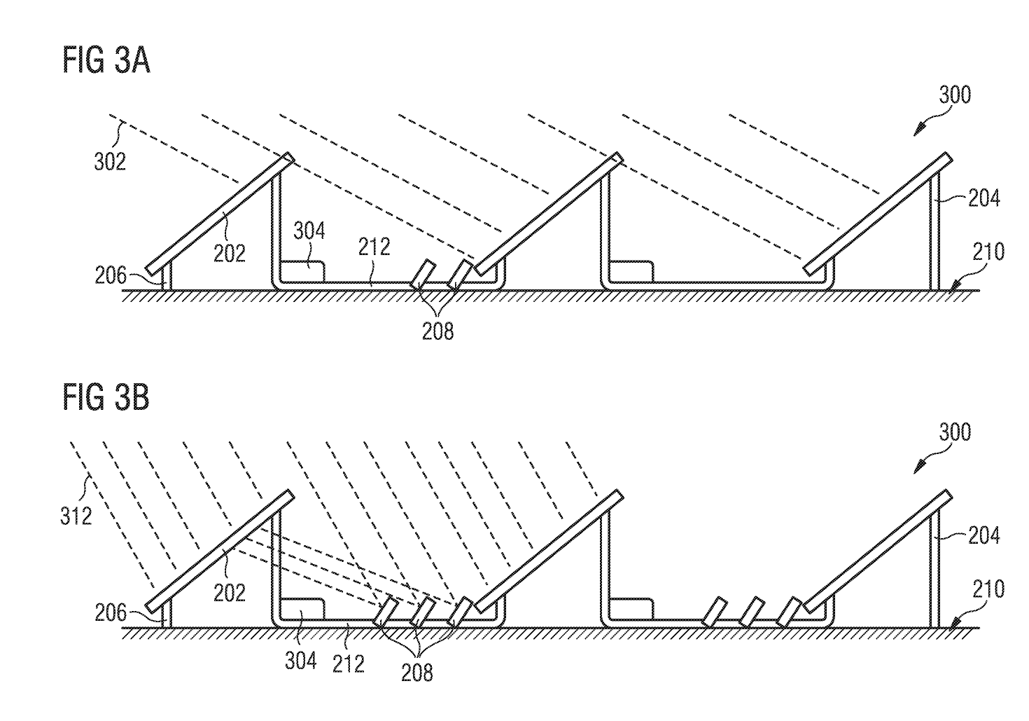

FIG. 3A and FIG. 3B show schematically cross sections of an arrangement 300 of photovoltaic modules 202 for light having different incident angles, e.g. for different times at a day or a year. The arrangement 200 according to various embodiments may be substantially similar to the arrangement of FIG. 2, e.g. FIG. 3A and FIG. 3B may be cross sectional views of the arrangement of FIG. 2 at different times.

As shown in the cross section in FIG. 3A, light 302 may fall directly on the front side of the photovoltaic modules, e.g. in the morning, evening or winter. Further shown in FIG. 3A, the arrangement may have a ballast 304, may be free of a reflector, e.g. if the ground is sufficiently reflecting, e.g. white colored; or may have one or more reflectors 208.

FIG. 3B may show the arrangement of FIG. 3A at a different time. Here, the light 312 may fall in a higher angle onto the arrangement 300 than in FIG. 3A. Thus, light 226 may fall into the in-between space between the photovoltaic modules and may be reflected from the reflector 208 and/or the ground 210 onto the back side of the photovoltaic modules. This way, the front side and the back side of the photovoltaic modules may generate an electrical energy from the incoming light. In various embodiments, the arrangement has a reflecting surface that reflects income light to at least a front side and/or back side of an adjacent photovoltaic module. The reflecting surface may be the reflecting surface of a reflector 208 and/or the ground 210. As an example, a reflecting surface may be a bright, e.g. white or silvery appearing surface of a ground, roof top, textile, foil, sheet, e.g. a ground or roof painted white a white paint; a ground or roof covered with a white or silvery appearing sheet, foil or textile.

As shown in FIG. 3A and FIG. 3B, the photovoltaic modules may be angled more strongly than a standard photovoltaic module in order to allow an illumination of the back side of the photovoltaic modules 202.

At least some of the mounting members 214 of the plurality of mounting members 214 may be configured to bear two or more reflectors 208. In various embodiments, at least a part of the mounting members 214 of the plurality of mounting members 214 has two or more reflectors 208 respectively and the two or more reflectors 208 may be configured to reflect light in different directions or from different directions.

At least a part of the mounting members 214 of the plurality of mounting members 214 may be configured to bear a ballast 304. In various embodiments, at least a part of the mounting members 214 of the plurality of mounting members 214 has a ballast 304 respectively. In one embodiment, at least some of the mounting members 214 of the plurality of mounting members 214 have a ballast 304 and the summarized ballast 304 of the plurality of mounting members 214 of a photovoltaic module row may be formed depending on the slope of the photovoltaic modules 202 of the photovoltaic module row.

The low side of the photovoltaic modules may be higher than a standard photovoltaic module. This way, light may fall through the gap between the ground and the lower edge of the photovoltaic module onto the ground 210 and/or a reflector 208 and may be reflected onto the back side of the photovoltaic module and/or the front side of the next or adjacent photovoltaic module.

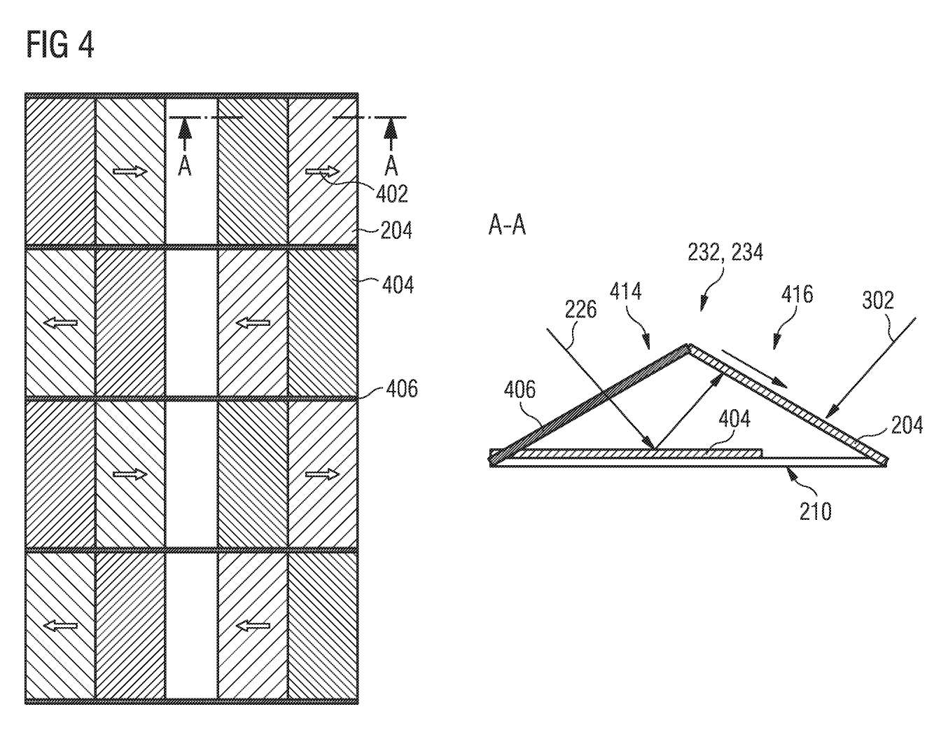

FIG. 4 shows a schematic top view and a schematic side view of an arrangement 400 of photovoltaic modules 204 according to various embodiments. The arrangement shown in FIG. 4 and according to various embodiments may be substantially similar to an above described arrangement.

In addition or alternatively, in various embodiments, at least one photovoltaic module row 232, 234 of photovoltaic modules may have at least a first photovoltaic module sub row 414 of photovoltaic modules 202 and a second photovoltaic module sub row 416 of photovoltaic modules 202. The front side and back side of the photovoltaic modules of the photovoltaic module sub rows may be oriented in different directions. As an example, the front side of the photovoltaic modules 202 of the first photovoltaic module sub row 414 may be respectively sloped substantially in a direction of East, and the front side of the photovoltaic modules of the second photovoltaic module sub row 416 may be respectively sloped substantially in a direction of West.

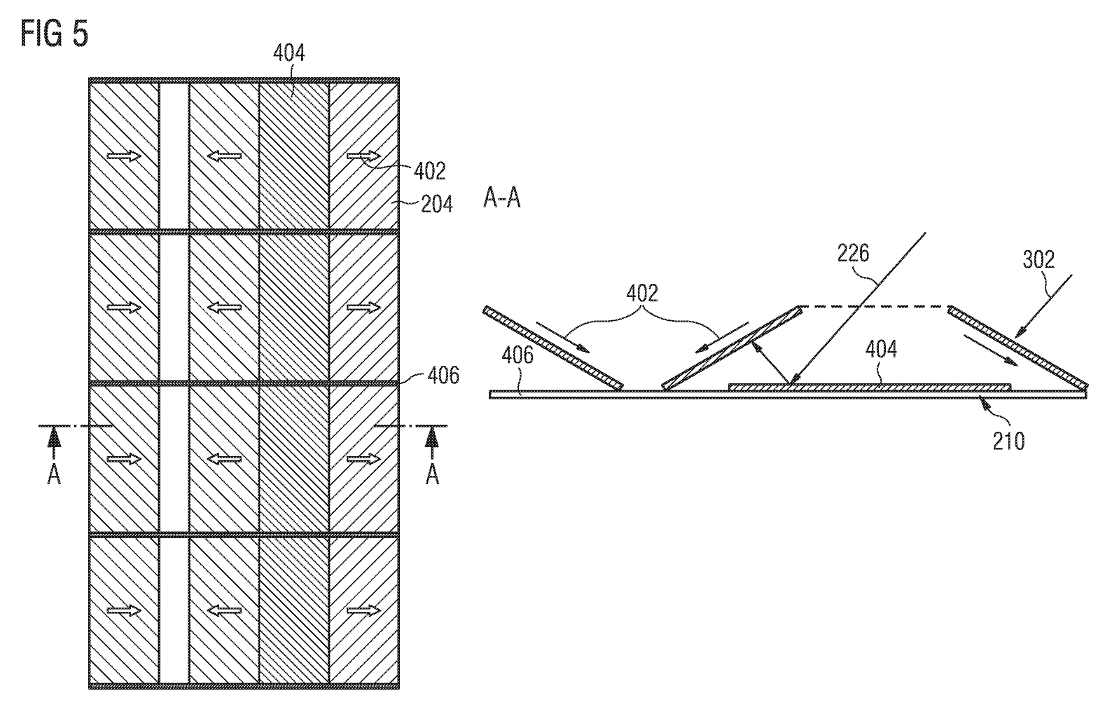

In various embodiments, a sloped or slanted photovoltaic module can be understood as a photovoltaic module that is arranged tilted, in other words: in an angle, on or above the ground 210. In FIG. 4 and FIG. 5, the respective slop of the respective photovoltaic modules is indicated using an arrow that points from high to low, as may be seen in addition from the cross sections A-A. In various embodiments, at least one angle of the photovoltaic module 202 regarding the ground 210 may be in a range from about 5 degrees to about 60 degrees, more specifically in a range from about 10 degrees to about 50 degrees, preferably in a range from about 15 degrees to about 40 degrees.

At least some of the plurality of reflectors 404 may be arranged facing the back side of the photovoltaic modules 202 of the first photovoltaic module sub row 414 and the second photovoltaic module sub row 416.

The photovoltaic modules 202 of the first photovoltaic module sub row 414 and the second photovoltaic module sub row 416 may be laterally spaced.

The arrangement may have a ground 210 and the photovoltaic modules 202 of the arrangement are arranged on the ground 210 and at least some of the reflectors 404 may be formed substantially parallel to the surface of the ground, e.g. at least the surface of the reflectors that reflects the incoming light to the back side of the photovoltaic modules respectively.

The photovoltaic modules 202 in the first and second photovoltaic module sub rows 414, 416 may be alternately arranged sloped mainly into Eastern and Western direction.

The reflectors 404 may be arranged basically horizontal and alternating with the photovoltaic modules 202 in each photovoltaic module sub row.

The photovoltaic modules 202 of a first photovoltaic module sub row 414 may be arranged offset to the photovoltaic modules 202 of the second photovoltaic module sub row 416 of a photovoltaic module row and at least one reflector 404 of the first photovoltaic module sub row 414 may be configured to reflect incoming light into the direction of the back side of an adjacent photovoltaic module 202 of the second photovoltaic module sub row 416 and at least one reflector 404 of the second sub may be configured to reflect incoming light into the direction of the back side of an adjacent photovoltaic module 202 of the first photovoltaic module sub row 414.

The plurality of reflectors 404 may be different portions of one or more reflecting structures. In other words, the reflector 404 may substantially be a single continuous reflecting structure, e.g. a white painted roof or ground, and, by arranging the plurality of photovoltaic modules 202 on that reflecting structure, the reflecting structure forms the plurality of reflectors 404 regarding the photovoltaic modules 202. In other words, the arrangement may be formed on a ground that has the plurality of reflectors 404.

At least some of the reflectors 404 of the plurality of reflectors 404 may have a plain reflecting surface regarding an incoming light that may be reflected to the back side of a photovoltaic module.

At least some of the reflectors 404 of the plurality of reflectors 404 may have a diffuse reflecting surface regarding an incoming light that may be reflected to the back side of a photovoltaic module.

At least some of the reflectors 404 of the plurality of reflectors 404 extend at least partly underneath at least one photovoltaic module 202, e.g. at least one photovoltaic module 202 of the photovoltaic module sub rows.

In other words, the plurality of photovoltaic modules may be arranged in one or more rows to form photovoltaic module rows wherein each photovoltaic module row has a first photovoltaic module sub row 414 and at least a second photovoltaic module sub row. The first and second photovoltaic module sub rows 412, 414 may have one or more photovoltaic modules 202 respectively. The front side of the at least one photovoltaic module 202 of the first photovoltaic module sub row may be arranged in an angle to the front side of the at least one photovoltaic module 202 of the second photovoltaic module sub row 416, e.g. the at least one photovoltaic module of the first photovoltaic module sub row 414 may be sloped in a direction of West and the at least one photovoltaic module of the second photovoltaic module sub row 416 may be sloped in a direction of East.

The at least one photovoltaic module 202 of the first photovoltaic module sub row may be arranged laterally displaced regarding at least one photovoltaic module 202 of the second photovoltaic module sub row 416, e.g. shown in FIG. 4. In other words, no photovoltaic module of the second photovoltaic module sub row 416 in the same photovoltaic module row may face the back side of a photovoltaic module of the first photovoltaic module sub row 414. Alternatively or in addition, the back side of the at least one photovoltaic module 202 of the first photovoltaic module sub row may be faced to the back side of at least one photovoltaic module 202 of the second photovoltaic module sub row 416, e.g. shown in FIG. 5 and described below in more detail.

In other words, considering a photovoltaic module row wherein every back side of a photovoltaic module 202 of the first photovoltaic module sub row 414 is faced, e.g. in an angle, by the back side of a photovoltaic module 202 of the second photovoltaic module sub row 416, the positions of some photovoltaic modules, e.g. every second, of the first and second photovoltaic module sub row 412, 414 are left empty, e.g. alternating as shown in FIG. 4. The empty positions may be left free or, alternatively, a reflector 404 may be arranged at the position wherein the reflector is configured to reflect incoming light that is falling in on the left empty position from a surface of the reflector into a direction to the back side of a photovoltaic module. This way, by leaving potential positions of photovoltaic modules within a photovoltaic module sub row empty or occupied by a reflector, the overall performance of the arrangement is reduced, but the investment costs for the arrangement too. Moreover, the specific yield of the arrangement may be significantly increased and may be comparable to the specific yield of a standard, monofacial photovoltaic module, as shown in subsequent table 1.

Table 1: Estimation of the specific energy yield of different arrangements of photovoltaic modules wherein South or East-West denote the orientation of the front sides (FS) of the photovoltaic modules of the arrangement, Standard denotes a monofacial photovoltaic module and bifacial a bifacial photovoltaic module. A back reflectance (Albedo) of 60% is considered for the bifacial photovoltaic modules, e.g. using a white colored roof top. A bifaciallity of 70% is considered for the bifacial photovoltaic modules (BS eq. back side).

| | South/ | South/ | East-West/ | East-West |
|---|---|---|---|---|
| | Standard | bifacial | Standard | bifacial |
| | (kW) | (kW) | (kW) | (kW) |
| performance | 71 | 71 | 130 | 65 |
| density/W/ | | | | |
| sqm | | | | |
| yield | 7.412 | 8.523 | 11.830 | 6.802 |
| (Berlin)/ | | | | FS: |
| kWh | | | | 5.915 kWh |
| | | | | BS: |
| | | | | 887 kWh |
| energy | 74 | 85 | 118 | 68 |
| density/ | | | | |
| kWh/sqm/a | | | | |
| energy yield | 1.044 | 1.200 | 910 | 1.046 |
| (Berlin)/ | | | | |
| kWh/kWp | | | | |

The first line of the table shows the performance density in Watt per square meters (W/sqm) of the different photovoltaic modules in the different orientations of the front side. The next line shows the yield for the above described arrangements for a surface area of the respective arrangement of 100 sqm for the location of Berlin. The third line shows the energy density of those arrangements per year. Finally, the last line of the table shows the energy yield of the different arrangements. As shown, the arrangement with bifacial photovoltaic modules in East-West orientation has about the same energy yield as a common arrangement of monofacial photovoltaic modules oriented in a direction of South (highlighted in bold in the table).

Thus, the arrangements according to various embodiments enable an arrangement of photovoltaic modules in East-West orientation without reducing the energy yield but with the additional advantage of smoothing the peak yield that occurs around noon. This way, the grid stress can be reduced and/or the domestic consumption can be increased.

FIG. 5 shows a schematic top view and a schematic cross section of an arrangement of photovoltaic modules according to various embodiments. The arrangement shown in FIG. 5 and according to various embodiments may be substantially similar to an above described arrangement.

The photovoltaic modules of the first and second photovoltaic module sub row may be arranged forming the shape of a roof ridge wherein a space is formed between the sides of the roof at the ridge. There is formed an opening or gap that is configured to let light fall into the space beneath. The space may have an extension of at least an extension of a photovoltaic module of the first and second photovoltaic module sub rows, e.g. the ones forming the space or gap. There is formed at least one reflector 404 between the photovoltaic modules of the first and second photovoltaic module sub row, as shown in FIG. 5. The reflector 208 may be substantially similar to an above described embodiment of a reflector.

The reflector may be substantially planar or flat and may be horizontally oriented to the ground 210. Thus, the reflector 404 may be configured to reflect at least a portion of the light 226 that is falling in through the space between the photovoltaic modules of the first and second photovoltaic module sub rows onto the reflector 404 into the direction of the respective back sides of the photovoltaic modules of the first and second modules, as shown in the cross section view A-A in FIG. 5.

Further, the space above the reflector 404 between the photovoltaic modules of the first and second photovoltaic module sub rows may be formed and/or allow an access for maintaining and installing the respective photovoltaic modules. This way, one reflector 404 may be used for at least two photovoltaic modules.

Further, the extension of the inter-row space may be reduced regarding a common arrangement of photovoltaic modules in an East-West orientation. In various embodiments, the extension of the inter-row space may be about or substantially zero. In other words, the arrangement may be substantially free of inter photovoltaic module row spacing. This way, the packaging density of the arrangement may be increased.

At least some of the plurality of reflectors 404 may be arranged as a reflector sub row between the first photovoltaic module sub row 414 and the second photovoltaic module sub row 416 in a photovoltaic module row. In addition, the reflectors 404 in the reflector sub row may be arranged substantially horizontal. In other words, at least some of the reflectors 404 of the reflector sub row may be configured to reflect incoming light 226 from the part of the reflectors 404 to the respective back side of photovoltaic modules 202 of the first photovoltaic module sub row 414 and second photovoltaic module sub row 416 of the photovoltaic module row that may be horizontally adjacent to the respective reflector 404 at different day time.

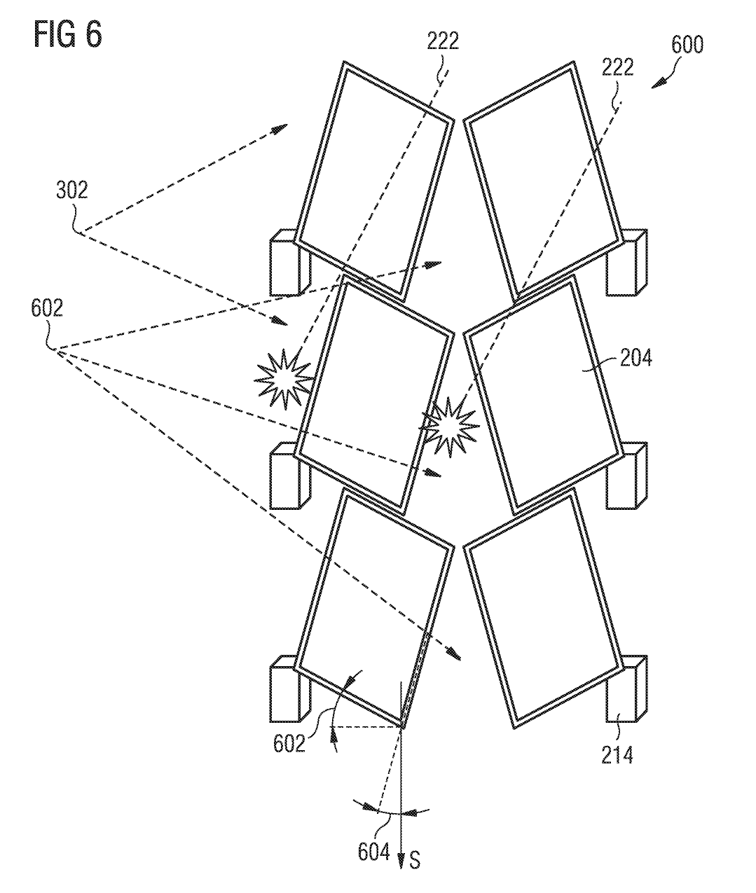

FIG. 6 shows a schematic perspective view of an arrangement 600 of photovoltaic modules according to various embodiments. The arrangement shown in FIG. 6 and according to various embodiments may be substantially similar to an above described arrangement. Thus, the arrangement 600 has a plurality of photovoltaic modules 202 and may have a plurality of reflectors 208. The photovoltaic modules 202 respectively have a light receiving front side and a light receiving back side. The plurality of photovoltaic modules 202 may be arranged in one or more rows to form photovoltaic module rows.

Each photovoltaic module row may be extending substantially in a direction of North-South. Each photovoltaic module row may have at least a first photovoltaic module sub row 414 of photovoltaic modules 202 with the front side of the photovoltaic modules 202 respectively slanted substantially in a direction of Southeast, and a second photovoltaic module sub row 416 of photovoltaic modules 202 with the front side of the photovoltaic modules 202 respectively slanted substantially in a direction of Southwest. The photovoltaic modules may be sloped to the ground 210 with a first angle 602 and may be slanted substantially by a second angle 604. The photovoltaic modules may be slanted regarding a portrait orientation or landscape orientation of the photovoltaic modules regarding the ground 210.

The back sides of the photovoltaic modules 202 of the first photovoltaic module sub row 414 and the second photovoltaic module sub row 416 of a photovoltaic module row may be at least partially facing each other.

At least some of the reflectors 208 of the plurality of reflectors 208 may be arranged facing the back side of the photovoltaic modules 202 of the first photovoltaic module sub row 414 and second photovoltaic module sub row 416.

A plurality of gaps 602 may be formed between at least some of the photovoltaic modules 202 of the plurality of photovoltaic modules 202. The extension of the gaps 602 may be formed by the extension of the inter-row space and/or the extension of the space between the first and second photovoltaic module sub rows. The extension of the gaps 602 may depend on the skew of the photovoltaic modules of the first and second photovoltaic module sub row. Due to the arrangement, the gaps 602 that would be in a common arrangement in itself dead space between the photovoltaic modules of the first and the second photovoltaic module sub rows is functionalized or, in other words, captured by the light that is reflected from the reflector 404.

Even further, the arrangements of the plurality of photovoltaic modules according to various embodiments allow reducing the installation costs.

The angle of the slope 602 or slanting 604 of the photovoltaic modules from horizontal may be larger than in an common arrangement of common photovoltaic modules, e.g. in a range from about 20° to about 85°, more specifically in a range from about 30° to about 80°, preferably in a range from about 40° to about 75°, respectively. This way, an efficient collection of light from the front side and the back side of the photovoltaic modules is enabled.

The at least two photovoltaic module sub rows and/or more photovoltaic module rows of photovoltaic modules may be arranged in a fishbone pattern.

Further, the total light management may be optimized when columns of facing pairs of photovoltaic modules are staggered.

In other words, the arrangement of photovoltaic modules may be configured for a slanted installation of photovoltaic modules, e.g. slanted from a landscape orientation or from a portrait orientation. The arrangement of photovoltaic modules may have one or more photovoltaic module rows. Each photovoltaic module row may be composed of at least two photovoltaic module sub rows with at least one photovoltaic module respectively. At least one photovoltaic module of this photovoltaic module sub rows is mounted in a substantially southeasterly orientation. At least one other photovoltaic module of another photovoltaic module sub row is mounted in a substantially southwesterly orientation and, hence, sloped or slanted substantially in different orientation. The photovoltaic modules of the photovoltaic module sub rows may be anchored at their respective bottom edge with hardware, e.g. mechanically or electromechanically, e.g. by means of mounting members as described in detail above and below. The photovoltaic modules of the photovoltaic module sub rows may lean with their backs towards each other so that one corner touches at the apex of the angle that the two photovoltaic modules form. Similar to the vertical arrangement of photovoltaic modules, the bifacial photovoltaic modules may require significantly higher arrangement angles than common arrangement of flat photovoltaic modules.

A plurality of light permeable gaps 602 may be formed between the slanted, sloped or angled photovoltaic modules. These gaps would be undesirable for an arrangement of common monofacial photovoltaic modules. However, this way, light falling in through these gaps may be reflected to the back side of the photovoltaic modules and, thus, the net power generation of an arrangement of bifacial photovoltaic modules may be increased. In other words, the gaps in the arrangement allow incoming light outside of the collection area of the front side of the photovoltaic modules to be collected either by direct collection on the active back side of the bifacial photovoltaic modules or by reflected collection from the ground 210.

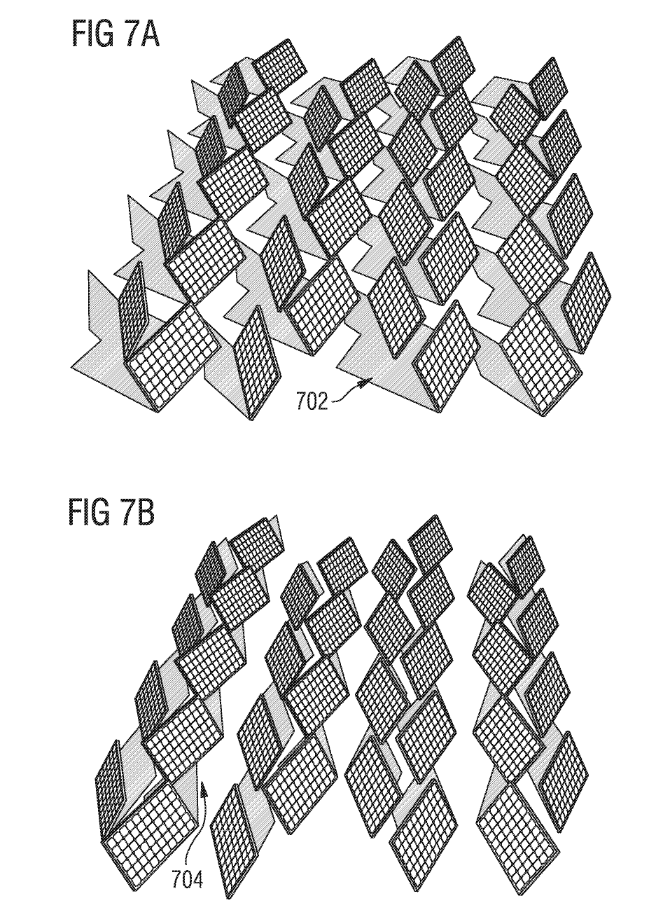

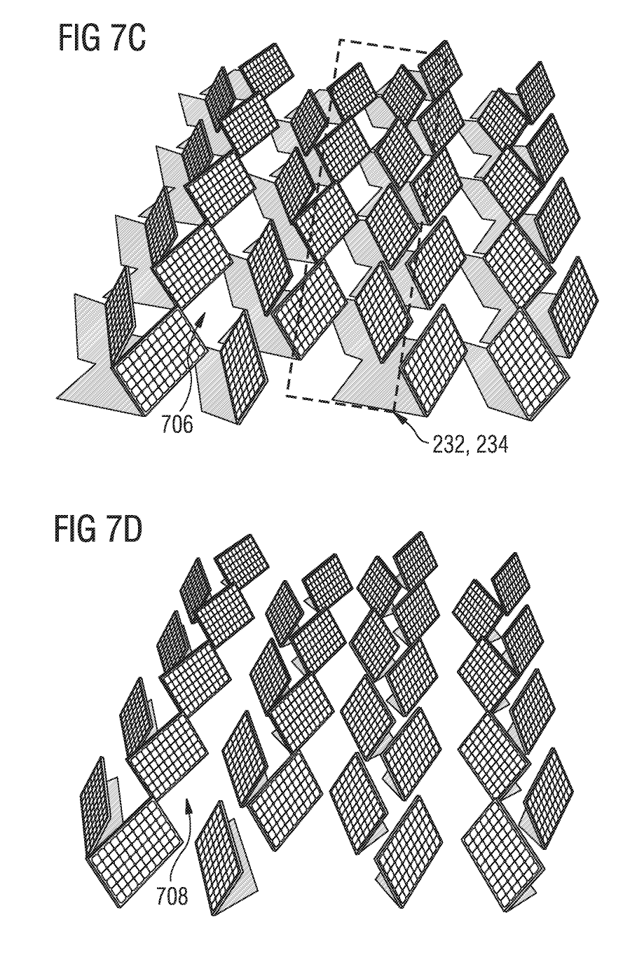

FIG. 7A to FIG. 7D show schematic perspective views of an arrangement of photovoltaic modules according to various embodiments at different times. FIG. 7A shows the illumination of the arrangement during morning or afternoon hours at a sunny day in spring. FIG. 7B shows the illumination of the arrangement during midday hours at a sunny day in winter. FIG. 7C shows the illumination of the arrangement during morning or afternoon hours at a sunny day in summer FIG. 7D shows the illumination of the arrangement during midday hours at a sunny day in winter.

As shown in the shadows 702, 706 of the photovoltaic modules in the arrangement in FIG. 7A and FIG. 7C only a little amount of light falls on the ground, e.g. a roof. As shown in the shadows 704, 708 in FIG. 7B and FIG. 7D, a larger amount of light may fall on the ground, but the modules may pick up reflection on the front side and on the back side.

In the morning, a light simulation, as shown in FIG. 7C, shows the formation of light columns between the photovoltaic modules that falls in towards the back side of the photovoltaic modules that are oriented with their front sides in a southwesterly orientation. A symmetric situation may occur in the morning or evening in spring, as shown in FIG. 7A. At the time of about noon, in other words: at high sun hours as shown in FIG. 7B and FIG. 7D, a significant amount of light falls in between the photovoltaic modules. Grounds or reflectors between the photovoltaic modules respectively having a high albedo reflecting surfaces may support to collect the light on both the front sides and back sides of the photovoltaic modules.

A low-profile corrugated secular reflector may be used in the arrangement. The reflector may scatter the light between the photovoltaic modules may increase the energy yield in a simple manner. Thus, the arrangement may allow generating the maximum kWh/Wₚ by using both the front side and the back side of the photovoltaic modules by collecting light that does not fall directly on the photovoltaic modules.

Since no arrangement installation can be perfectly optimized for light collection at all times of the day and the year, the arrangements according to various embodiments provide above described effect(s) regarding common arrangements and, thus, justifies the in principle unfortunate arrangement.

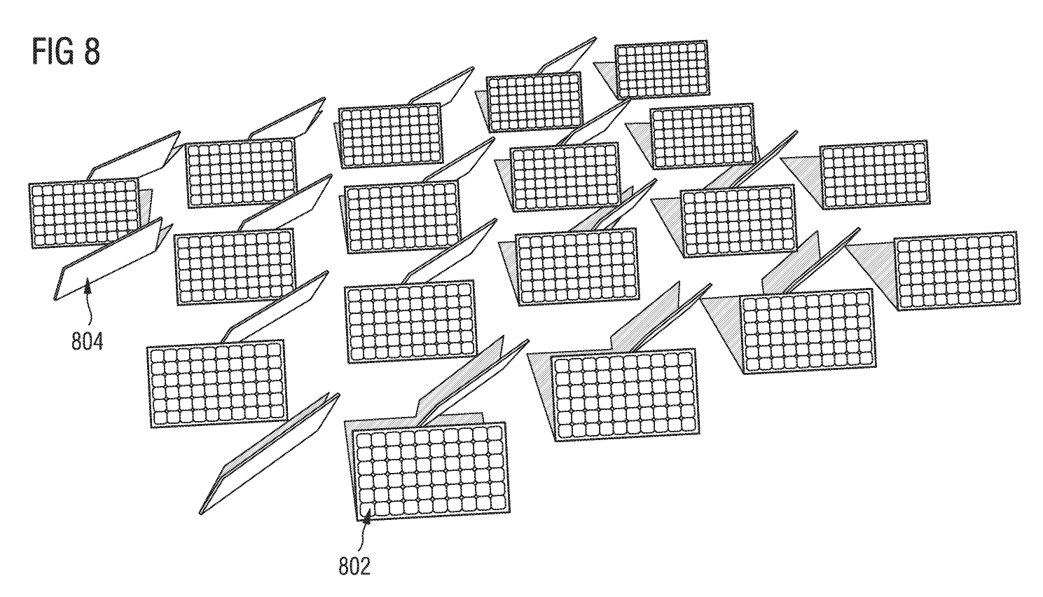

FIG. 8 shows a schematic perspective view of an arrangement of photovoltaic modules according to various embodiments. The front side 802 of the photovoltaic modules may have a good direct illumination and, in addition, a forward scattering from a white colored roof, e.g. for ˜⅔ of the day. The back side 804 of the photovoltaic modules may have some direct back illumination in the morning and evening and, in addition, good reflection from the white roof. However, a trade-off may be that the angle of incidence on the photovoltaic modules may be higher than on an arranged common photovoltaic module, e.g. as high as during mid-summer at mid-day, e.g. about 50 degrees.

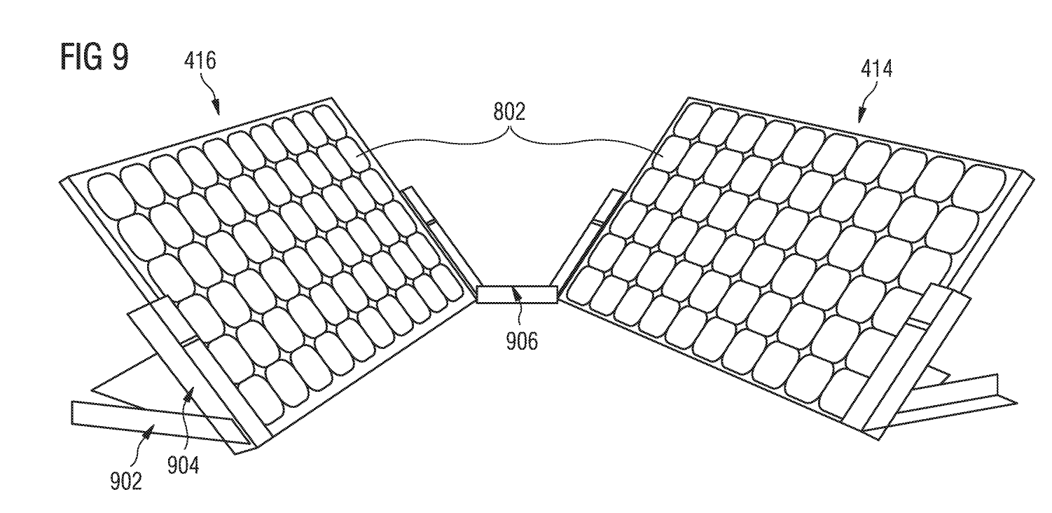

FIG. 9 shows a schematic perspective view of an arrangement of photovoltaic modules according to various embodiments.

The mounting members may be formed and arranged to form a network or grid. The mounting members may have different segments 902, 904, 906 that mount the photovoltaic modules in a predetermined angle to the ground on the ground and may interconnect the photovoltaic modules with each other. This way, the need for ballast may be reduced or becomes optional. This may be realized by use of the strength of the frame of the photovoltaic modules to cut down on racking materials. An, e.g. C-channel formed by the elements 902, 904, may support the short edges of the photovoltaic modules, e.g. for about 50% of the height of the photovoltaic modules.

At least two photovoltaic modules 202 may be connected with a mounting member or a segment 906 of the mounting member respectively. At least some of the mounting members of the plurality of mounting members may be configured to connect at least some of the photovoltaic modules of the plurality of photovoltaic modules 202 as a grid or network.

At least some of the mounting members 214 of the plurality of mounting members 214 have a channel-shaped segment 904 for mounting at least a part of at least one side of a photovoltaic modules 202 in the channel respectively.

At least a part of the plurality of mounting members 214 may be configured to mount, in other words: capture, the front edge of at least one photovoltaic module, e.g. by means of the channel-shaped segment 904. In addition, it may also mount or capture the back edge of another photovoltaic module, e.g. of the same photovoltaic module row, the same photovoltaic module sub row or another photovoltaic module sub row. The mounting members may be configured that the photovoltaic modules may slide down onto the mounting member from the top. The mounting members or segments 906 therefrom may be formed substantially as a flat bar that spans the gaps along the ground between the photovoltaic modules. In addition, the mounting member may have channel supports for the back corners of two photovoltaic modules and/or the front corners of the next two photovoltaic modules.

In various embodiments, the mounting members may be configured to connect the photovoltaic modules in a grid, e.g. connect the respective front corners of two modules and, thus, forming an A-shape. Then, the respective back corners of another two photovoltaic modules from adjacent columns may be connected by a mounting member.

The alternating angles of the photovoltaic modules in the arrangements according to various embodiments make it less likely to form a cohesive ‘sail’ for wind uplift. Thus, in various embodiments, e.g. to further interconnect the photovoltaic modules of the arrangement, photovoltaic module row or photovoltaic module sub row, the mounting members may have at least a third bar that mechanically joins the photovoltaic modules into a net. The benefit of a net arrangement is that the need for a ballast is reduced. In various embodiments, only the edges of the grid are held down, e.g. with extra weight. The middle of the grid may be held down by the grid connection to the other photovoltaic modules.

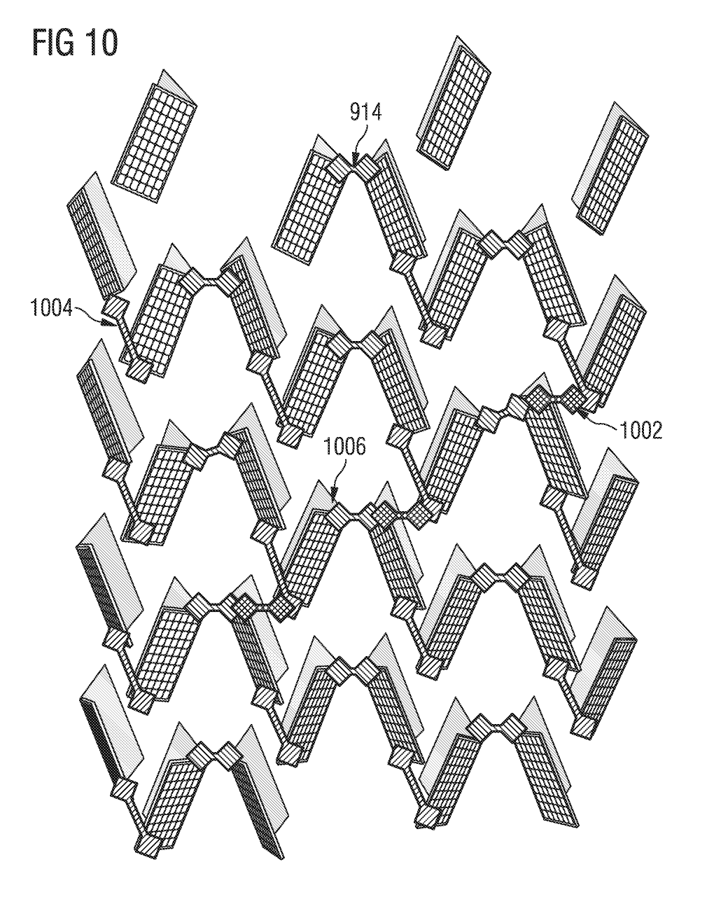

In other words, to mount or secure the photovoltaic modules in this arrangement of photovoltaic modules, the mounting members may have angle segments, e.g. in an inverted U-, inverted V-, A-, L- or C-channel-shape, to support the short sides of the photovoltaic modules at a predetermined angle as shown in FIG. 9. The C-channel, as an example, may have a segment 902 at the bottom of the channel that snaps the photovoltaic module into place when fully engaged. The segments 902 may be connected to each side of the photovoltaic modules and may not be attached to each other apparently. However, the C-channels may be networked to nearby supports, e.g. on other photovoltaic modules. The resulting network of photovoltaic modules, e.g. as shown in FIG. 10, with varying angles to the wind, may have the effect of preventing updraft and, thus, ballasts may become optional. Further, the inherent strength of the arrangement and/or of the photovoltaic modules may be increased. Thus, the racking materials of the mounting members may be cut down. Using frame-less photovoltaic modules, the edge channels of the mounting members may be extended higher to provide reinforcement to the laminates of the photovoltaic modules.

In various embodiments, the mounting members may have one or more segments that are formed by one or more parts. As an example, at least some mounting members may have a ridged, molded plastic body. The body may be arranged, e.g. laid, on the ground, e.g. the roof of a building or ground. The body may be substantially free of legs. In other words, in various embodiments, at least some mounting members may only have a bottom part that has at least one portion, e.g. in a grove-shape or channel-shape, that is arranged to receive or accommodate at least one photovoltaic module. This way, the photovoltaic modules may be slipped or inserted into the grove-shaped or channel-shaped portion of the mounting members for mounting or arranging the photovoltaic modules on a ground. Thus, the installation and/or maintenance of the arrangement may be simplified.

In various embodiments, as illustrated in FIG. 9, at least some of the mounting members are formed or arranged, e.g. having respectively designed segments 902, 904, to arrange connected photovoltaic module in an angle (slope angle—SA) to the ground. Alternatively or in addition, at least some of the mounting members are formed or arranged to arrange connected photovoltaic module in an angle (lateral angle—LA) to each other. The lateral angle between two adjacent modules, e.g. that are connected by a common mounting member, may be less than about 180 degrees, e.g. in a range from about 60 degrees to about 120 degrees.

The net result of the arrangements according to various embodiments may be that a given amount of area, e.g. rooftop, land, etc., may be covered with fewer photovoltaic modules per area than for a standard arrangement of unifacial photovoltaic modules. In various embodiments, the light collection and, thus, the energy yield, as shown in table 1, and the net power generation may be similar to a denser arrangement of unifacial photovoltaic modules. However, the installation cost may be lower; both in number of photovoltaic modules per Wₚ output, and in cost per kWh produced each year. To accomplish this, the optimal positioning for the front side collection of the photovoltaic modules and/or the close packing density may be given up. If only the packing density is amended, the back-side light collection may not be significantly improved unless the photovoltaic modules are mounted much higher or an extensive amount of light reflectors are installed.

FIG. 10 shows a schematic perspective view of an arrangement of photovoltaic modules according to various embodiments. The arrangement of FIG. 10 may be substantially similar to an above described embodiment.

As shown in FIG. 10, in various embodiments, mounting members having two racking segments may be used. A short racking segment 1006 may be used to tie the closest points of photovoltaic modules in the arrangement together and, thus, supporting one edge respectively on opposite photovoltaic modules. A longer racking segment 1004 may connect back edges of the photovoltaic modules in the staggered photovoltaic module rows and, thus, supporting another part of the plurality of photovoltaic modules. The racking segments may be laid out in a grid, and then the photovoltaic modules may be slid down into the C-channels and lock in. A third set of cross-brace segments 1002 of the mounting members may be used to complete the network if needed.

Example 1 is an arrangement of a plurality of photovoltaic modules. Each photovoltaic module has a light receiving front side and a light receiving back side. The photovoltaic modules of the plurality of photovoltaic modules are arranged in one or more rows to form photovoltaic module rows. One or more photovoltaic module rows may be extended substantially in a direction of around North-South and the front sides of the photovoltaic modules of the one or more photovoltaic module rows may be sloped substantially in a direction of predominantly North or South. The arrangement further has a plurality of mounting members wherein each mounting member defines a space between respective two photovoltaic modules in one photovoltaic module row that are mechanically connected with the respective mounting member. Each mounting member of the plurality of mounting members has a bottom part, a long leg and a short leg. The long leg and the short leg respectively extend upwards from an end of the bottom part. Each mounting member further has a reflector configured to reflect light to the back side of at least one of the connected photovoltaic modules.

In Example 2, the subject matter of Example 1 can optionally include that the reflector may be arranged in the space between the photovoltaic modules that may be connected with the connecting member.

In Example 3, the subject matter of Example 1 or 2 can optionally include that the reflector is arranged in the space between the long leg and the short leg.

In Example 4, the subject matter of Example 1 to 3 can optionally include that the arrangement further has one or more ballasts. At least some of the mounting members of the plurality of mounting members bear at least one ballast of the one or more ballasts. A ballast is a material that is used to increase the stability of the arrangement. This way, the ballast may loaded depending on the shape and size of the arrangement, e.g. PV modules in the center region of a grid arrangement may not require a ballast since those PV modules may be fixed to the ground by other PV modules.

In Example 5, the subject matter of Example 1 to 4 can optionally include that at least some of the mounting members of the plurality of mounting members may bear two reflectors arranged in parallel with each other. This way, the amount of light that is reflected onto the back side of a photovoltaic module may be increased.

Example 6 is an arrangement having a plurality of photovoltaic modules and a plurality of reflecting surfaces. Each photovoltaic module has a light receiving front side and a light receiving back side. The photovoltaic modules of the plurality of photovoltaic modules and the plurality of reflectors may be arranged in one or more rows to form photovoltaic module rows. One or more photovoltaic module rows may be extended substantially in a direction of predominantly North to South. Each photovoltaic module row may have at least a first photovoltaic module sub row with the front side of the photovoltaic modules respectively sloped substantially in a direction of predominantly East; and a second photovoltaic module sub row with the front side of the photovoltaic modules respectively sloped substantially in a direction of predominantly West. At least one module of the first photovoltaic module sub row may be connected mechanically with at least one module of the second photovoltaic module sub row. At least one of the plurality of reflecting surfaces may be arranged basically horizontal and may replace one or more of the photovoltaic modules in the same photovoltaic module sub.

In Example 7, the subject matter of Example 6 can optionally include that at least one reflecting surface has or is a surface of a ground or a roof or textile or foil or sheet that may be arranged basically horizontal on a ground or a roof. and alternating with the photovoltaic modules in each photovoltaic module sub row.

In Example 8, the subject matter of Example 6 or 7 can optionally include that the photovoltaic modules of a first photovoltaic module sub row may be arranged offset to the photovoltaic modules of the second photovoltaic module sub row of a photovoltaic module row and at least one reflecting surface of the first photovoltaic module sub row reflects may be configured to reflect incoming light into the direction of the back side of an adjacent photovoltaic module of the second photovoltaic module sub row and at least one reflecting surface of the second sub may be configured to reflect incoming light into the direction of the back side of an adjacent photovoltaic module of the first photovoltaic module sub row.

In Example 9, the subject matter of Example 6 to 8 can optionally include that at least some of the plurality of reflecting surfaces may be arranged as a reflecting surface sub row between the first photovoltaic module sub row and the second photovoltaic module sub row.

In Example 10, the subject matter of Example 6 to 9 can optionally include that at least some of the reflecting surfaces may have a bright appearance, preferably white or silvery, and arranged substantially horizontal.

In Example 11, the subject matter of Example 6 to 10 can optionally include that at least some of the reflecting surfaces may be configured to reflect incoming light to the respective back side of adjacent photovoltaic modules of the first photovoltaic module sub row and the second photovoltaic module sub row at different day times.

In Example 12, the subject matter of Example 6 to 11 can optionally include that at least some of the reflecting surfaces of the plurality of reflecting surfaces may have a diffuse reflecting surface regarding an incoming light that may be reflected to the back side of an adjacent photovoltaic module.

In Example 13, the subject matter of Example 6 to 12 can optionally include that at least some of the reflecting surfaces of the plurality of reflecting surfaces extend at least partly underneath at least one adjacent photovoltaic module.

Example 14 is an arrangement of a plurality of photovoltaic modules. Each photovoltaic modules respectively has a light receiving front side and a light receiving back side. The photovoltaic modules of the plurality of photovoltaic modules are arranged in one or more rows to form photovoltaic module rows. A space is formed respectively between photovoltaic modules of a respective photovoltaic module row. One or more photovoltaic module rows are extended substantially in a direction of predominantly North to South. Each photovoltaic module row has a first photovoltaic module sub row of photovoltaic modules with the front side of the photovoltaic modules respectively slanted substantially in a direction of predominantly South East or predominantly North East, and a second photovoltaic module sub row of photovoltaic modules with the front side of the photovoltaic modules respectively slanted substantially in a direction of predominantly South West or predominantly North West. The front sides of two adjacent photovoltaic modules of the first photovoltaic module sub row and the second photovoltaic module sub row may be at least partially facing each other.

In Example 15, the subject matter of Example 14 can optionally include that the arrangement may further have a plurality of mounting members that are arranged to secure a plurality of photovoltaic modules at a slope angle between 20 degrees to 85 degrees to the ground.

In Example 16, the subject matter of Example 14 or 15 can optionally include that two photovoltaic modules of the plurality of the photovoltaic modules may connected mechanically with each other at a lateral angle of less than 180 degrees.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An arrangement, comprising:
a plurality of photovoltaic modules;
each photovoltaic module comprising a light receiving front side and a light receiving back side;
wherein the photovoltaic modules of the plurality of photovoltaic modules are arranged in one or more rows to form photovoltaic module rows, and
wherein one or more photovoltaic module rows are extended substantially in a direction of around North-South and the front sides of the photovoltaic modules of the one or more photovoltaic module rows are sloped substantially in a direction of predominantly North or South, and
a plurality of mounting members;
wherein each mounting member defines a space between respective two photovoltaic modules in one photovoltaic module row that are mechanically connected with the respective mounting member;
wherein each mounting member of the plurality of mounting members comprises:
a bottom part;
a long leg; and
a short leg;
wherein the long leg and the short leg respectively extend upwards from an end of the bottom part, and
a reflector configured to reflect light to the back side of at least one of the connected photovoltaic modules.

2. The arrangement of claim 1,
wherein the reflector is arranged in the space between the photovoltaic modules that are connected with the connecting member.

3. The arrangement of claim 1,
wherein the reflector is arranged in the space between the long leg and the short leg.

4. The arrangement of claim 1, further comprising:
one or more ballasts;
wherein at least some of the mounting members of the plurality of mounting members bear at least one ballast of the one or more ballasts.

5. The arrangement of claim 1,
wherein at least some of the mounting members of the plurality of mounting members bear at least two reflectors arranged in parallel with each other.

6. An arrangement, comprising:
a plurality of photovoltaic modules;
a plurality of reflecting surfaces;
each photovoltaic module comprising a light receiving front side and a light receiving back side;
wherein the photovoltaic modules of the plurality of photovoltaic modules and the plurality of reflecting surfaces are arranged in one or more rows to form photovoltaic module rows, and
wherein one or more photovoltaic module rows are extended substantially in a direction of predominantly North to South, and
wherein each photovoltaic module row comprises:
a first photovoltaic module sub row with the front side of the photovoltaic modules respectively sloped substantially in a direction of predominantly East; and
a second photovoltaic module sub row with the front side of the photovoltaic modules respectively sloped substantially in a direction of predominantly West;
wherein at least one module of the first photovoltaic module sub row is connected mechanically with at least one module of the second photovoltaic module sub row, and
at least one of the reflecting surfaces is arranged basically horizontal and is replacing one or more of the photovoltaic modules in the same module sub row.

7. The arrangement of claim 6,
wherein at least one reflecting surface comprises a surface of a ground or a roof or textile or foil or sheet that is arranged basically horizontal on a ground or a roof.

8. The arrangement of claim 6,
wherein the photovoltaic modules of a first photovoltaic module sub row are arranged offset to the photovoltaic modules of the second photovoltaic module sub row of a respective photovoltaic module row and at least one reflecting surface in the first photovoltaic module sub row is configured to reflect incoming light into the direction of the back side of an adjacent photovoltaic module of the second photovoltaic module sub row and at least one reflecting surface in the second photovoltaic module sub row is configured to reflect incoming light into the direction of the back side of an adjacent photovoltaic module of the first photovoltaic module sub row.

9. The arrangement of claim 6,
wherein at least some reflecting surface of the plurality of reflecting surface are arranged as a reflecting surface sub row between the first photovoltaic module sub row and the second photovoltaic module sub row.

10. The arrangement of claim 6,
wherein at least some of the reflecting surfaces comprise a bright appearance, and are arranged substantially horizontal.

11. The arrangement of claim 6,
wherein at least some of the reflecting surfaces are configured to reflect incoming light to the respective back side of adjacent photovoltaic modules of the first photovoltaic module sub row and the second photovoltaic module sub row at different day times.

12. The arrangement of claim 6,
wherein at least some of the reflecting surfaces of the plurality of reflecting surfaces comprise a diffuse reflecting surface regarding an incoming light that is reflected to the back side of an adjacent photovoltaic module.

13. The arrangement of claim 6,
wherein at least some of the reflecting surfaces of the plurality of reflecting surfaces extend at least partly underneath at least one adjacent photovoltaic module.

14. An arrangement, comprising:
a plurality of photovoltaic modules,
each photovoltaic module comprising a light receiving front side and a light receiving back side,
wherein the photovoltaic modules of the plurality of photovoltaic modules are arranged in one or more rows to form photovoltaic module rows and wherein a space is formed respectively between photovoltaic modules of a respective photovoltaic module row,
wherein one or more photovoltaic module rows are extended substantially in a direction of predominantly North to South, and
wherein each photovoltaic module row comprises:
a first photovoltaic module sub row of photovoltaic modules with the front side of the photovoltaic modules respectively slanted substantially in a direction of predominantly South East or predominantly North East;
a second photovoltaic module sub row of photovoltaic modules with the front side of the photovoltaic modules respectively slanted substantially in a direction of predominantly South West or North West; and
wherein the front sides of two adjacent photovoltaic modules of the first photovoltaic module sub row and the second photovoltaic module sub row are at least partially facing each other.

15. The arrangement of claim 14, further comprising:
a plurality of mounting members that are arrange to secure a plurality of photovoltaic modules at a slope angle between 20 degrees to 85 degrees to the ground.

16. The arrangement of claim 14, wherein two photovoltaic modules of the plurality of the photovoltaic modules are connected mechanically with each other at a lateral angle of less than 180 degrees.
